(19) United States
(12) Patent Application Publication
(10) Pub. No.: US 2005/0047859 A1
(43) Pub. Date: Mar. 3, 2005

(54) Grommet-mounting structure and grommet

(75) Inventors: Tsutomu Santanda, Kosai-shi (JP); Tatsuo Ogawa, Kosai-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/923,879

(22) Filed: Aug. 24, 2004

(30) Foreign Application Priority Data
Aug. 25, 2003 (JP) P.2003-299984

(51) Int. Cl. B60D 7/00

(52) U.S. Cl. 403/384

(57) ABSTRACT

A structure of mounting a grommet, includes a first member, a second member, a link mechanism which connects the first member and the second member so that the first member and the second member are movable toward and away from each other, a grommet which is arranged between the first member and the second member. The grommet includes a first fixing portion fixed to the first member, a second fixing portion fixed to the second member, a flexible tubular portion extending between the first fixing portion and the second fixing portion, and an attaching portion provided on the tubular portion. A grip member grips the attaching portion. The tubular portion is fixed to at least one of the link mechanism, the first member and the second member through the grip member.

### BACKGROUND OF THE INVENTION

This invention relates to a structure of mounting a grommet for the passage of a wire harness (installed, for example, in an automobile or the like) therethrough so as to protect it, and also relates to this grommet.

Generally, one example of those members which are opened and closed relative to a vehicle body (first member) through a link mechanism is a trunk lid (second member). In addition to tail lamps, a license plate lamp and a high-mount stop lamp, a wiper is mounted on the trunk lid in some kinds of cars as in a hatch back-type car. Therefore, it is necessary to install a wire harness between the vehicle body and the trunk lid so as to supply electric power to these parts.

This wire harness is passed through the bore of a grommet, and is protected by this grommet, the grommet including a first fixing portion of an annular shape for being fixed to the vehicle body, a second fixing portion of an annular shape for being fixed to the trunk lid, and a flexible tubular portion extending between the first fixing portion and the second fixing portion.

When the flexible tubular portion of the grommet is freely deformed during the opening and closing of the trunk lid, there is a fear that the wire harness is bitten by the trunk lid when the trunk lid is closed, so that the wire harness within this tubular portion is cut. Therefore, in the related structure, a band is attached to a suitable portion of the tubular portion of the grommet, and this band is fixed to a predetermined portion, thereby preventing the tubular portion from being bitten by the trunk lid (see, for example, JP-A-2000-311534).

In the above related grommet-mounting structure, however, the band-attaching portion of the tubular portion of the grommet is not specified, and therefore there is a possibility that when the trunk lid is repeatedly opened and closed, the band is displaced in the axial direction of the tubular portion, and the fixed position of the tubular portion shits, so that the tubular portion is bitten by the trunk lid when the trunk lid is closed.

### SUMMARY OF THE INVENTION

It is therefore an object of the present invention to provide a grommet-mounting structure as well as the grommet, in which a fixed position of a tubular portion is maintained.

In order to achieve the above object, according to the present invention, there is provided a structure of mounting a grommet, comprising:
a first member;
a second member;
a link mechanism, which connects the first member and the second member so that the first member and the second member are movable toward and away from each other;
a grommet, which is arranged between the first member and the second member for protecting an elongate member which pass through the grommet, the grommet including:
   a first fixing portion, which has an annular shape and is fixed to the first member
   a second fixing portion, which has an annular shape and is fixed to the second member;
   a flexible tubular portion, which extends between the first fixing portion and the second fixing portion; and
   an attaching portion, which is provided on the tubular portion; and
a grip member, which grips the attaching portion,
wherein the tubular portion is fixed to at least one of the link mechanism, the first member and the second member through the grip member.

Here, the first member is, for example, a vehicle body of a vehicle, and the second member is, for example, a trunk lid, and the elongate member is, for example, a wire harness.

In the grommet-mounting structure of this construction, the tubular portion of the grommet has the attaching portion to be gripped by the grip member, and therefore even when the first and second members are repeatedly moved toward and away from each other, the grip member is prevented from being displaced in the direction of the axis of the tubular portion. Therefore, the fixed position of the tubular portion is maintained, and the tubular portion is prevented from being bitingly held between the first member and the second member.

Therefore, this grommet-mounting structure solves a problem (as encountered with the related structure) that when the trunk lid is repeatedly opened and closed, the band is displaced in the axial direction of the tubular portion, and the fixed position of the tubular portion shifts, so that the tubular portion is bitten by the trunk lid when the trunk lid is closed.

Preferably, the attaching portion has a generally cylindrical shape. Ribs which are larger in diameter than the tubular portion are formed at axial opposite ends of the attaching portion, respectively.

In the grommet-mounting structure of this construction, the grip member grips the cylindrical attaching portion in such a manner that the tubular portion is rotatable relative to the grip member, and therefore the tubular portion is prevented from being twisted when the first and second members are moved toward and away from each other. And besides, the ribs of a larger diameter abut against the grip member to limit the axial movement of the tubular portion, and therefore the axial displacement of the tubular portion is positively prevented.

Preferably, the grip member is fixed to the link mechanism.

In the grommet-mounting structure of this construction, the tubular portion is prevented from being bitten by the link mechanism when the first and second members are moved toward and away from each other.

According to the present invention, there is also provided a grommet for protecting an elongate member, and for being arranged between a first member and a second member which are movable toward and away from each other through a link mechanism, the grommet comprising:
a first fixing portion, which has an annular shape for being fixed to the first member;
a second fixing portion, which has an annular shape for being fixed to the second member; and
a flexible tubular portion, which extends between the first fixing portion and the second fixing portion,
wherein the tubular portion is provided with an attaching portion to be griped by a grip member for fixing the tubular portion to at least one of the link mechanism, the first member and the second member.

The present invention solves a problem (as encountered with the related structure) that when the trunk lid or the like is repeatedly opened and closed, the band is displaced in the axial direction of the tubular portion, and the fixed position of the tubular portion shifts, so that the tubular portion is bitten by the trunk lid when the trunk lid is closed. Therefore, even when the first and second members are repeatedly moved toward and away from each other, the grip member is prevented from being displaced in the direction of the axis of the tubular portion. Therefore, the fixed position of the tubular portion is maintained, and the tubular portion is prevented from being bitingly held between the first member and the second member.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a view showing a grommet according to a preferred embodiment of the present invention;

FIG. 2 is a view as seen from a direction of arrow A of FIG. 1;

FIG. 3 is a cross-sectional view taken along the line III-III of FIG. 2;

FIG. 4 is a perspective view showing the whole of a clip;

FIG. 5 is a cross-sectional view taken along the line V-V of FIG. 4;

FIG. 6 is a view as seen from a direction of arrow B of FIG. 5;

FIG. 7 is a view showing modified step portions; and

FIG. 8 is a view showing a modified thickened portion of a tubular portion.

### DETAILED DESCRIPTION OF THE PREFERRED EMBODIMENTS

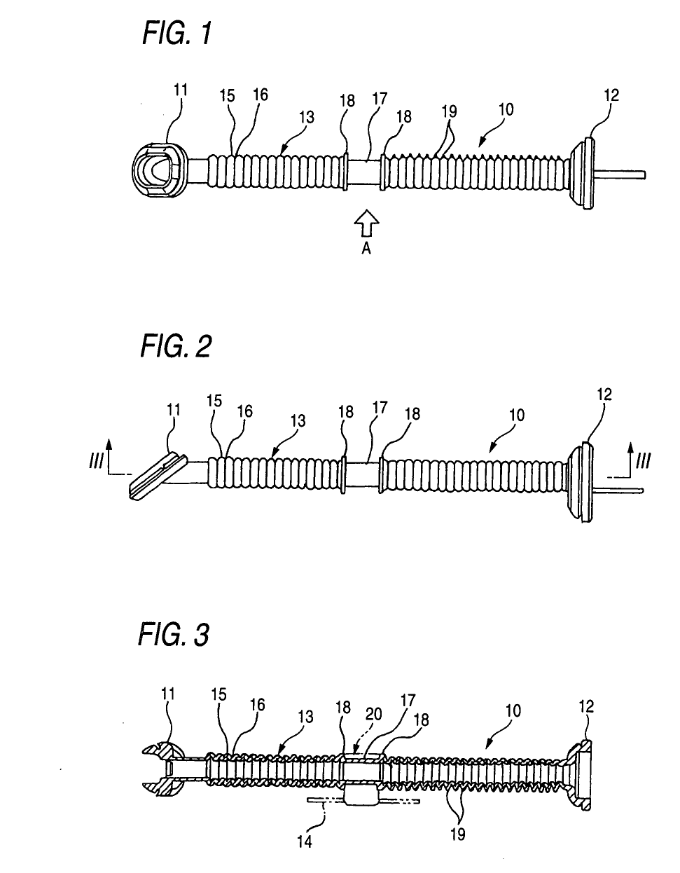

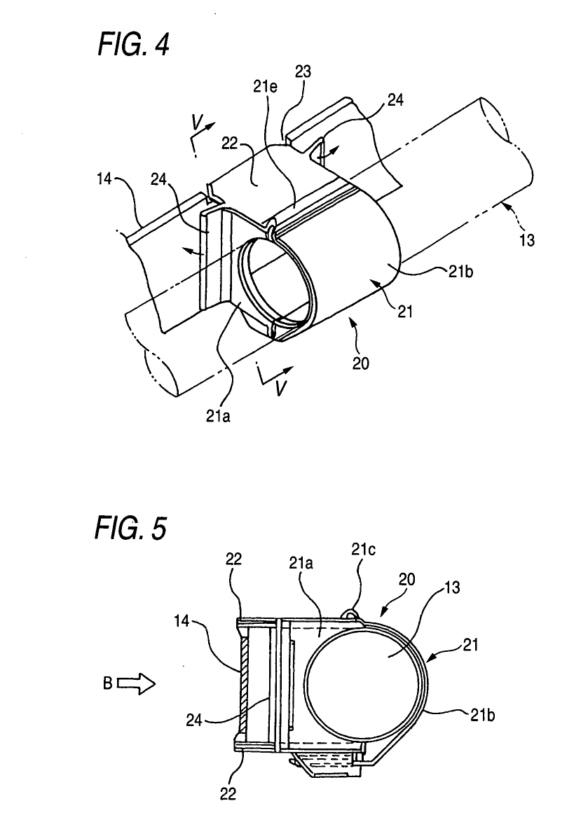

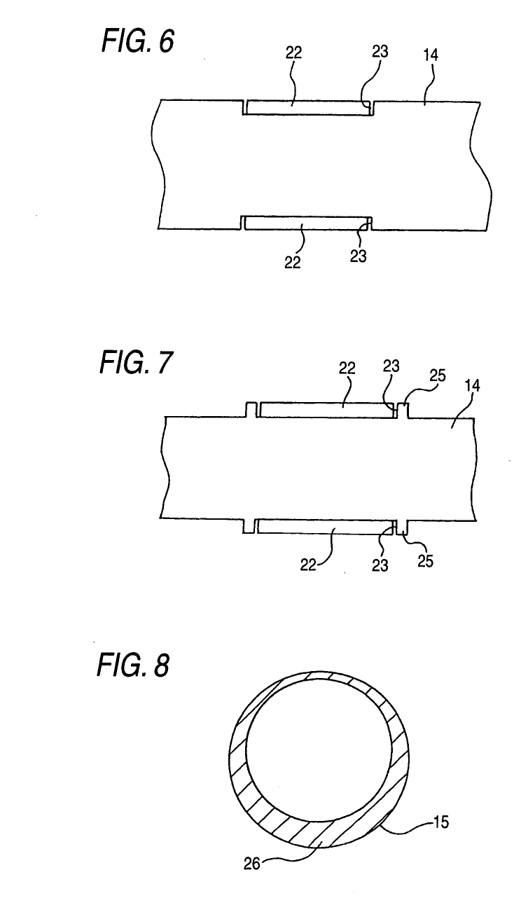

A preferred embodiment of the present invention will now be described in detail with reference to the drawings. FIG. 1 is a view showing one preferred embodiment of a grommet of the invention, FIG. 2 is a view as seen from a direction of arrow A of FIG. 1, FIG. 3 is a cross-sectional view taken along the line III-III of FIG. 2, FIG. 4 is a perspective view showing the whole of a clip, FIG. 5 is a cross-sectional view taken along the line V-V of FIG. 4, FIG. 6 is a view as seen from a direction of arrow B of FIG. 5, FIG. 7 is a view showing modified step portions, and FIG. 8 is a view showing a modified thickened portion of a tubular portion.

As shown in FIGS. 1 to 3, the grommet 10 (embodying the invention) for the passage of a wire harness (not shown) (which is installed between a vehicle body (not shown), serving as a first member, and a trunk lid (not shown) which serves as a second member, and can be opened and closed relative to the vehicle body through a link mechanism) therethrough so as to protect the wire harness includes a first fixing portion 11 of an annular shape for being fixed to the vehicle body, a second fixing portion 12 of an annular shape for being fixed to the trunk lid, and a flexible tubular portion 13 extending between the first fixing portion 11 and the second fixing portion 12.

The tubular portion 13 has a bellows-like shape, and includes alternate larger-diameter portions 15 and smaller-diameter portions 16 which are arranged along a common axis, and an attaching portion 17 of a cylindrical shape for being gripped by the clip 20 serving to a grip member (described later) is provided at a generally axially-central portion of the tubular portion 13. Ribs 18, larger in diameter than the tubular portion 13, are formed at axial opposite ends of the attaching portion 17, respectively. Convex portions 19 are formed respectively at those portions of the larger-diameter portions 15 of the tubular portion 13 which are adapted to contact the trunk lid, and therefore these portions are molded into a larger thickness than the other portions, so that those portions of the larger-diameter portions 15 for contact with the trunk lid are reinforced.

The clip 20 grips the attaching portion 17, and in this condition the clip fixes the tubular portion 13 to a link 14 of the link mechanism. As shown in FIGS. 4 and 5, this clip has an cylindrical portion 21 for gripping the attaching portion 17.

The cylindrical portion 21 comprises a half-cylindrical member 21a, and a half-cylindrical member 21b which is releasably attached to the half-cylindrical member 21a through a hinge 21c or the like so as to be opened and closed relative thereto. A pair of arms 22 for engagement respectively with widthwise opposite side edges of the link 14 are integrally connected to the half-cylindrical portion 21a, and each of the arms 22 continuously extends in the longitudinal direction of the link 14. As shown in FIG. 6, step portions 23 for respectively retaining the pair of arms 22 are formed respectively at the widthwise opposite side edges of the link 14 with which the pair of arms 22 can be engaged. Blades 24 are formed respectively at axial opposite ends of the half-cylindrical member 21a, and these blades 24 are bent toward the surface of the link 14 so as to resiliently contact this surface.

The attaching portion 17 of the tubular portion 13 is gripped by the cylindrical portion 21 of the clip 20, and in this condition the pair of arms 22 are retainingly engaged with the step portions 23 of the link 14, respectively, and also the blades 24 are bent toward the surface of the link 14 to be held in resilient contact with this surface, thereby fixing the tubular portion 13 to the link 14 of the link mechanism through the clip 20. In this fixed condition, the tubular portion 13 is rotatable relative to the cylindrical portion 21 of the clip 20.

In the above structure of mounting the grommet 10, the attaching portion 17 for being gripped by the clip 20 is provided at the tubular portion 13 of the grommet 10, and therefore even when the trunk lid is repeatedly opened and closed, the clip 20 is prevented from being displaced in the direction of the axis of the tubular portion 13. Therefore, the fixed position of the tubular portion 13 is maintained, and the tubular portion 13 is prevented from being bitingly held between the vehicle body and the trunk lid.

And besides, the clip 20 grips the cylindrical attaching portion 17 in such a manner that the tubular portion 13 is rotatable relative to the cylindrical portion 21 of the clip 20, and therefore the tubular portion 13 is prevented from being twisted during the opening and closing of the trunk lid. And besides, the ribs 18 of a larger diameter abut against the cylindrical portion 21 of the clip 20 to limit the axial movement of the tubular portion 13, and therefore the axial displacement of the tubular portion 13 is positively prevented.

Furthermore, the clip 20 is fixed to the link 14 of the link mechanism, and therefore the tubular portion 13 is prevented from being bitten by the link mechanism when the trunk lid is opened and closed.

The grommet-mounting structure of the present invention is not limited to the above embodiment, and suitable modifications and improvements can be made.

For example, in the above embodiment, although the trunk lid is shown as the second member, a side door, a tail gate, a bonnet, a slide door, a cabin (cab) of a truck (forwardly tiltable from a closed position to an open position) or others can be used instead of the trunk lid, in which case the present invention can be applied.

In the above embodiment, although the clip 20 is fixed to the link mechanism, this arrangement is not always necessary, and the clip 20 may be fixed to the vehicle body or the trunk lid.

Furthermore, in the above embodiment, the step portions 23, provided respectively at the widthwise opposite side edges of the link 14, are formed by notches, respectively. However, instead of these step portions, step portions 23 may be formed by forming projections 25 on the widthwise opposite side edges of the link 14, the projections 25 on each side edge being spaced from each other in the axial direction as shown in FIG. 7.

Furthermore, in the above embodiment, the convex portions 19 are formed respectively at those portions of the larger-diameter portions 15 of the tubular portion 13 for contact with the trunk lid, thereby providing the reinforcing portions. However, instead of this construction, there may be used a construction in which the circular inner and outer peripheries of each of relevant larger-diameter portions 15 are eccentric with respect to each other, thereby forming the thickened portion 26 at that portion of each of the larger-diameter portions 15 of the tubular portion 13 for contact with the trunk lid, thus providing a reinforcing portion, as shown in FIG. 8.

The material, shape, dimensions, form, number, disposition, etc., of the link mechanism, the first member, the second member, the elongate member, the first fixing portion, the second fixing portion, the tubular portion, the grommet, the attaching portion, the clip, the ribs and so on, illustrated in the above embodiment, are arbitrary, and are not limited in so far as the invention can be achieved.

1. A structure of mounting a grommet, comprising:
a first member;
a second member;
a link mechanism, which connects the first member and the second member so that the first member and the second member are movable toward and away from each other;
a grommet, which is arranged between the first member and the second member for protecting an elongate member which pass through the grommet, the grommet including:
a first fixing portion, which has an annular shape and is fixed to the first member
a second fixing portion, which has an annular shape and is fixed to the second member;
a flexible tubular portion, which extends between the first fixing portion and the second fixing portion; and
an attaching portion, which is provided on the tubular portion; and
a grip member, which grips the attaching portion,
wherein the tubular portion is fixed to at least one of the link mechanism, the first member and the second member through the grip member.

2. The structure as set forth in claim 1, wherein the attaching portion has a generally cylindrical shape; and
wherein ribs which are larger in diameter than the tubular portion are formed at axial opposite ends of the attaching portion, respectively.

3. The structure as set forth in claim 1, wherein the grip member is fixed to the link mechanism.

4. A grommet for protecting an elongate member, and for being arranged between a first member and a second member which are movable toward and away from each other through a link mechanism, the grommet comprising:
a first fixing portion, which has an annular shape for being fixed to the first member;
a second fixing portion, which has an annular shape for being fixed to the second member; and
a flexible tubular portion, which extends between the first fixing portion and the second fixing portion,
wherein the tubular portion is provided with an attaching portion to be griped by a grip member for fixing the tubular portion to at least one of the link mechanism, the first member and the second member.

5. The structure as set forth in claim 4, wherein the attaching portion has a generally cylindrical shape; and
wherein ribs which are larger in diameter than the tubular portion are formed at axial opposite ends of the attaching portion, respectively.
